(19) United States
(12) Patent Application Publication
(10) Pub. No.: US 2017/0319431 A1
(43) Pub. Date: Nov. 9, 2017

(54) MULTI-POINT ACUPRESSURE

(71) Applicant: David Yong Lee, Thousand Oaks, CA (US)

(72) Inventor: David Yong Lee, Thousand Oaks, CA (US)

(21) Appl. No.: 15/147,104

(22) Filed: May 5, 2016

(51) Int. Cl. A61H 39/04

(52) U.S. Cl. CPC A61H 39/04; A61H 2205/12; A61H 2201/168; A61H 2201/1695; A61H 2205/065

(57) ABSTRACT

A multi-point acupressure method includes selecting a set of therapeutic locations on a subject's body according to one or more therapeutic selection parameters, applying an acupressure device to each of therapeutic location from the set of therapeutic locations, wherein the set of therapeutic locations includes one or more bi-horary therapeutic locations, and the bi-horary therapeutic locations.

### TECHNICAL FIELD

The disclosed technology relates generally to alternative medicine, and more particularly, some embodiments relate to multi-point acupressure and acupuncture treatments.

### BACKGROUND

Alternative medicine techniques, such as acupressure and acupuncture, have been known to treat many diseases effectively and efficiently. Acupressure and acupuncture techniques are generally complementary to other therapies and do not aggravate a disease. These techniques can be used in conjunction with chemotherapy, radiation therapy, medications, chiropractic, and physiotherapy.

Generally, treatment results from alternative medicine techniques have been inconsistent. Some of this inconsistency in results stems from single-ailment focus in treatment, for example, by selecting a treatment protocol based on only a single ailment. In the case of acupuncture, consistency in treatment results has been shown to improve by selecting a treatment protocol that targets multiple ailments by selecting a protocol that combines acupuncture locations on a subject's body using multiple horary points. There are five known horary points that have been identified to correspond to treatment of particular ailments. Each of these five horary points has historically been labeled, for convenience, using the name of an element of nature, for example: 1) wood; 2) fire; 3) earth; 4) water; and 5) metal. Acupuncture protocols that target multiple horary points have been shown to produce more consistent treatment results. However, acupuncture requires puncturing of skin with needles, and may be uncomfortable for some subjects.

### BRIEF SUMMARY OF EMBODIMENTS

Embodiments disclosed herein are directed towards a multi-point acupressure and acupuncture treatments. In some embodiments, a method for stimulating a combination of acupressure points using a plurality of acupressure device includes selecting, based on one or more therapeutic selection parameters, a set of therapeutic locations and applying an acupressure device to each therapeutic location. For example, the method may include applying a first acupressure device to a first location, applying a second acupressure device to a second location, applying a third acupressure device to a third location, and applying a fourth acupressure device to a fourth location. In some examples, the method may also include applying a fifth acupressure device of the plurality of acupressure devices to a fifth location selected from the set of therapeutic locations.

In some embodiments, the set of therapeutic locations includes one or more bi-horary therapeutic locations. For example the bi-horary therapeutic locations may include of a wood location, a fire location, an earth location, a metal location, and a water location. In some examples, the wood location is a LR1 location, a LR3 location, a GB44 location, or a GB41 location, the fire location is a HT8 location, a HT4 location, a SI2 location, or a SI5 location, the earth location is a SP3 location, a SP9 location, a ST43 location, or a ST36 location, the metal location is a LU8 location, a LU11 location, a L15 location, or a LI1 location, and the water location is a KD10 location, a KD2 location, a UB40 location, or a UB66 location.

In some embodiments, the one or more therapeutic selection parameters include a type of ailment affecting a body part. The therapeutic selection parameters may also include a plurality of ailments affecting one or more body parts. For example, application of pressure to one or more therapeutic locations may beneficially affect a corresponding organ, and be used to treat specific diseases or ailments. In some examples, the acupressure devices each include a flat substrate and a plurality of knobs protruding from a distal surface of the flat substrate. The devices may be secured with an adhesive component to therapeutic points on the subject's body. For example, the adhesive component may be an adhesive tape.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A illustrates a perspective proximal-side view of an example acupressure device, consistent with embodiments disclosed herein.

FIG. 1B illustrates a cross-section proximal-side view of an example acupressure device, consistent with embodiments disclosed herein.

FIG. 1C illustrates a perspective distal-side view of an example acupressure device, consistent with embodiments disclosed herein.

FIG. 1D illustrates a cross-section distal-side view of an example acupressure device, consistent with embodiments disclosed herein.

FIG. 2 illustrates an example treatment protocol combining multiple horary points, consistent with embodiments disclosed herein.

FIG. 3 illustrates an example treatment protocol combining multiple horary points, consistent with embodiments disclosed herein.

FIG. 4 illustrates an example treatment protocol combining multiple horary points, consistent with embodiments disclosed herein.

FIG. 5 illustrates an example treatment protocol combining multiple horary points, consistent with embodiments disclosed herein.

FIG. 6A illustrates an example set of treatment points on a human foot.

FIG. 6B illustrates an example set of treatment points on a human hand.

FIG. 7 illustrates an example treatment protocol combining multiple treatment points, consistent with embodiments disclosed herein.

FIG. 8A illustrates an example set of treatment points on a human hand.

FIG. 8B illustrates an example set of treatment points on a human foot.

FIG. 9 illustrates an example treatment protocol combining multiple treatment points, consistent with embodiments disclosed herein.

FIG. 10 is a flow chart illustrating an example method for applying a multi-point treatment protocol, consistent with embodiments disclosed herein.

FIG. 11 is a diagram illustrating relationships between five types of horary points.

FIG. 12 is a table of fifty example acupressure points.

FIG. 13A is a table of example acupressure point combinations, consistent with embodiments disclosed herein.

FIG. 13B is a table of example acupressure point combinations, consistent with embodiments disclosed herein.

FIG. 13C is a table of example acupressure point combinations, consistent with embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments disclosed herein are directed to alternative medicine, and more particularly, some embodiments relate to multi-point acupressure and acupuncture treatments. For example, some embodiments disclosed herein are directed to a method of selecting a combination of five therapeutic locations on a subject based on a set of therapeutic parameters and applying or securing an acupressure device to each selected therapeutic location. The set of therapeutic parameters may include the type of disease or ailment the subject is experiencing, as well as groupings of horary points based on tables disclosed herein. Although several embodiments disclosed herein are made in reference to acupressure, a person of ordinary skill in the art would appreciate that the same techniques and principles may also be applied to acupuncture, as well as other forms of therapy. Reference is also made to multi-point therapeutic techniques that include five points as an example. However, a person of ordinary skill in the art would appreciate that other numbers and combinations of therapeutic points may be combined (e.g., in three point, four point, or other multi-point combinations).

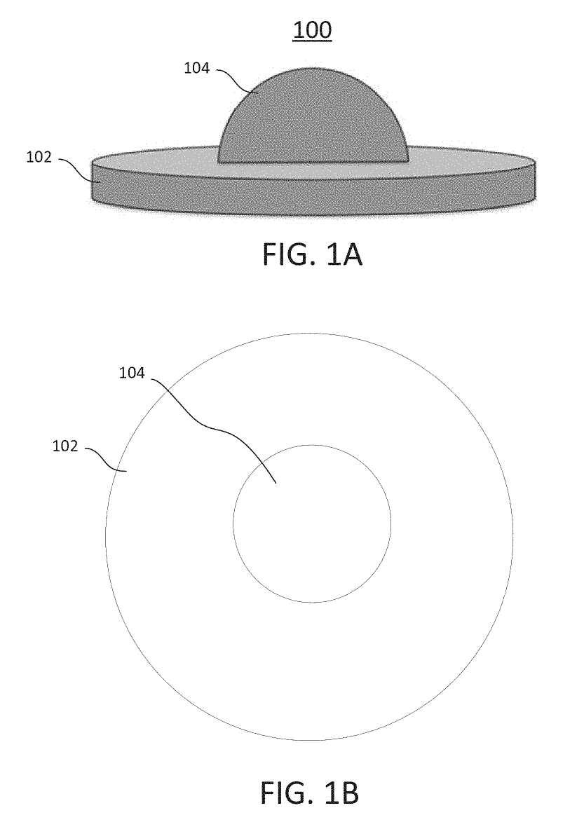

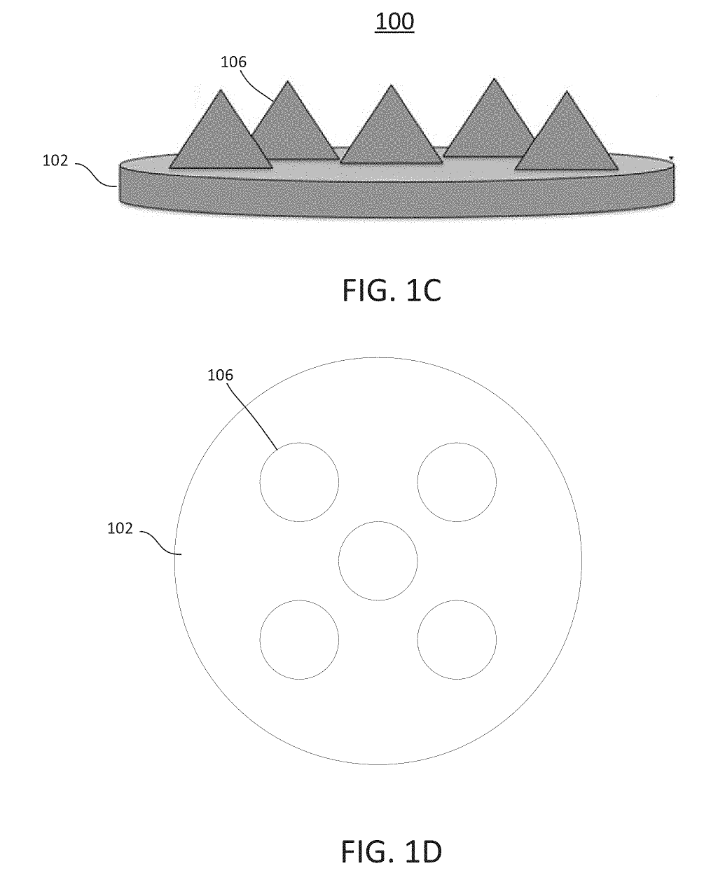

FIG. 1A illustrates a perspective proximal-side view of an example acupressure device. As illustrated, acupressure device 100 may include a flat substrate component 102. In some examples, flat substrate component 102 may be disk shaped, although other shapes are possible, such as square, rectangle, hexagonal, octagonal, or other shapes as would be known in the art and as would facilitate holding in a human hand or applying to a subject's body. In some examples, substrate component 102 may be a non-geometric shape. Substrate component 100 may range in size from a few millimeters across to a few centimeters across. In some examples, a knob structure 104 may protrude from a proximal surface of substrate component 102. Knob structure 104 may be shaped to contact a subject's body part and a specific therapeutic point if the acupressure device is inverted (i.e., the proximal surface contacts the subject's body as opposed to the distal surface).

FIG. 1B illustrates a cross-section proximal-side view of example acupressure device 100. As illustrated, knob structure 104 may be positioned centrally on substrate component 102.

FIG. 1C illustrates a perspective distal-side view and FIG. 1D illustrates a cross-section distal-side view of example acupressure device 100. As illustrated multiple knob structures 106 may protrude from a distal surface of substrate component 102. For example, the knob components may protrude between one millimeter to one centimeter from the distal surface. The exact dimensions and arrangement of knob components 106 on substrate component 102 may vary as would be known in the art.

In some examples, either surface of substrate component 102 may be coated with an adhesive to affix or secure the acupressure device 100 to a subject's body part at a specific therapeutic location. In other examples, an adhesive tape or bandage may be used to affix or secure the acupressure device 100 to a subject's body part. Acupressure device 100 may be formed from materials such as wood, plastic, metal, rubber, silicon, or other materials as would be known in the art. In some examples, organic materials, such as beans, may be used as an acupressure device and affixed or secured to a subject's body using an adhesive material, such as a tape or bandage.

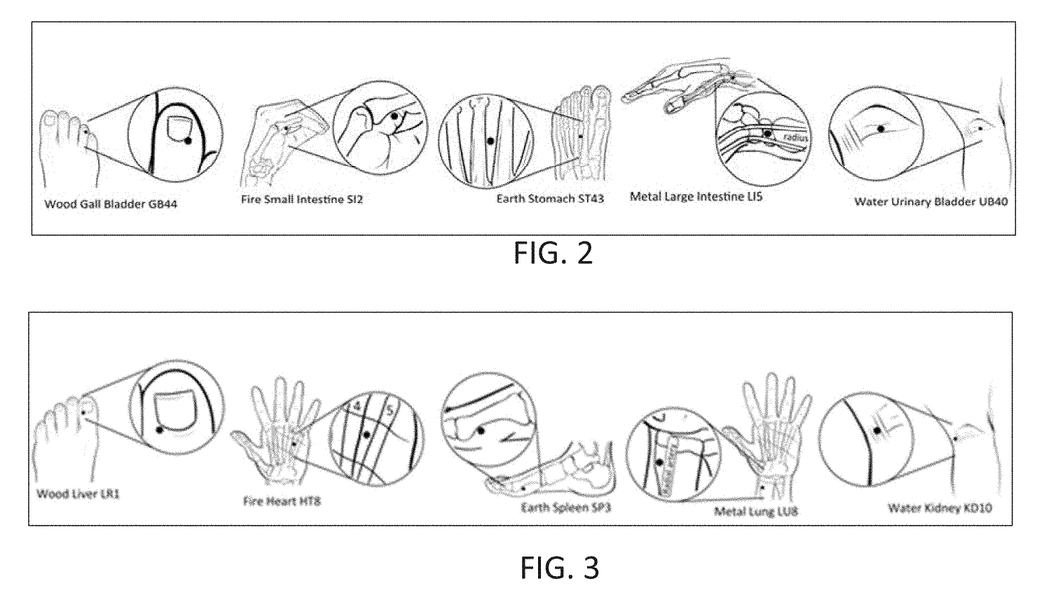

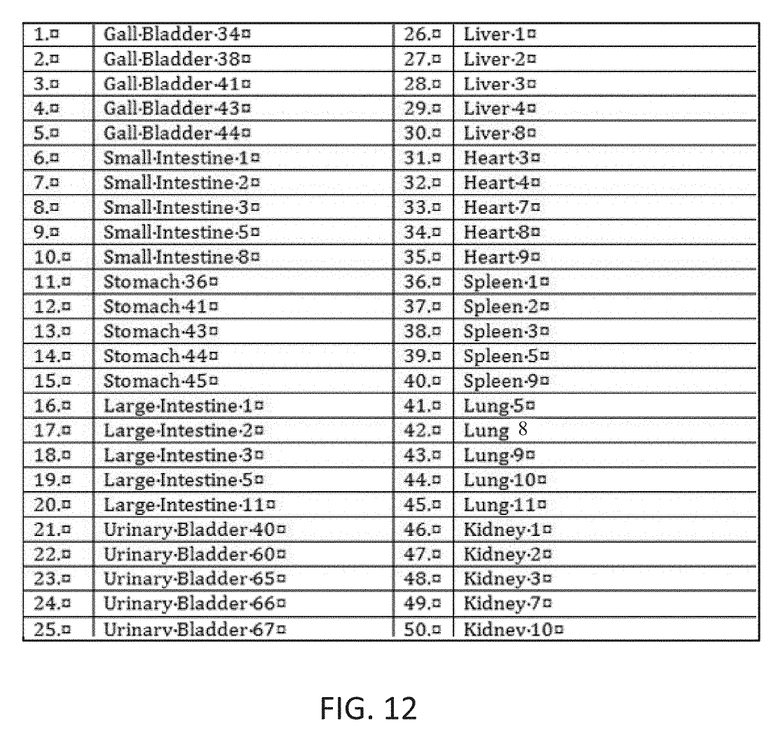

FIG. 2 illustrates an example treatment protocol combining multiple therapeutic horary points. As used herein, a therapeutic point or location may identify any location on a subject's body to which an acupressure or acupuncture device may be applied to achieve a therapeutic impact on the subject. Observable therapeutic impacts to particular internal organs have been categorized by in relation to corresponding therapeutic points on a subject's body, for example, as indicated in the table shown in FIG. 12. Examples of internal organs that may be therapeutically impacted by applying an acupuncture or acupressure device to a subject's body part include the gall bladder, small intestine, stomach, large intestine, urinary bladder, liver, heart, spleen, lungs, and kidney. Other body parts not listed may also be therapeutically impacted.

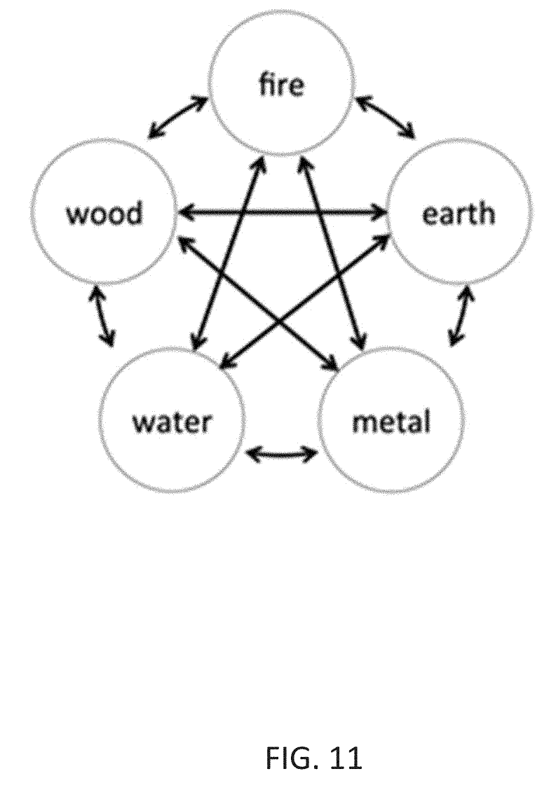

The list of therapeutic points may then be categorized by channels that associate one or more therapeutic points with one or more internal organs. Five observable channels, referred to by the aliases fire, earth, metal, water, and wood (the horary channels) have been cataloged, and are interrelated, as illustrated in FIG. 11. A person of ordinary skill in the art would understand that groups of therapeutic points can be cataloged by each horary channel, and are generally referred to by their related horary channel and internal organ. For example, Wood GB44 refers to location 44 on a subject's body that therapeutically impacts the gall bladder (GB) and is cataloged in the wood horary channel, whereas Water UB40 refers to location 40 on a subject's body that therapeutically impacts the urinary tract and bladder and is cataloged in the water horary channel. FIG. 2, then, illustrates a combination of five therapeutic locations for applying an acupuncture or acupressure device (e.g., acupressure device 100), wherein each therapeutic location falls within a distinct horary channel. As illustrated, the combination includes Wood GB44, Fire SI2 (small intestine 2), Earth ST43 (stomach 43), Metal LI5 (large intestine 5), and Water UB40. The specific points on the subject's body that map to these locations are shown in FIG. 2, i.e., points on the subject's foot, hand, wrist, and knee as shown. Using this combination, a distinct acupressure or acupuncture device may be secured to each of these therapeutic points (i.e., using an adhesive tape or coating) to simultaneously stimulate each horary channel.

FIG. 3 illustrates another example treatment protocol combining multiple horary points. As illustrated in FIG. 3, acupuncture or acupressure devices may be applied to Wood LR1 (liver 1), Fire HT8 (heart 8), Earth SP3 (spleen 3), Metal LU8 (lung 8) and Water KD10 (kidney 10). The specific locations of these points on the subject's body are shown in FIG. 3.

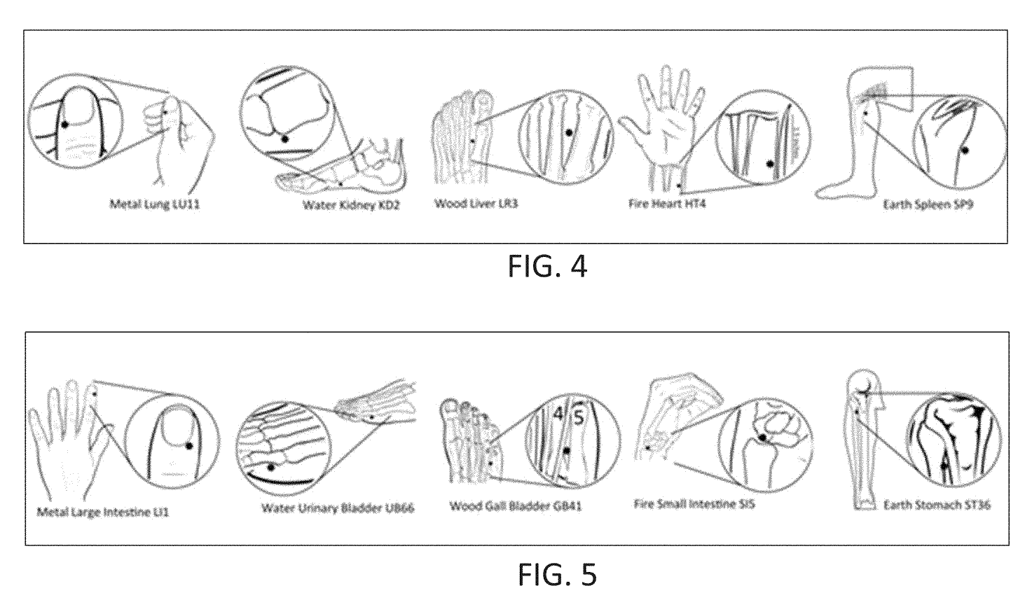

FIG. 4 illustrates another example treatment protocol combining multiple horary points. As illustrated in FIG. 4, acupuncture or acupressure devices may be applied to Metal LU11, Water KD2, Wood LR3, Fire HT4, and Earth SP9. Similarly, FIG. 5 illustrates a combination of Metal LI1, Water UB66, Wood GB41, Fire SI5, and Earth ST36. By using any of these combinations, acupuncture or acupressure devices may simultaneously or sequentially applied or secured to a therapeutic location corresponding to each horary channel, as to stimulate each horary channel in a single therapeutic protocol. By doing so, specific ailments to one or more body parts may be simultaneously treated, including treatment of stress, anxiety, depression, headache, cramps, musculoskeletal disorders, and other disorders as known in the art, the treatment of which corresponds to a particular set of therapeutic locations described above.

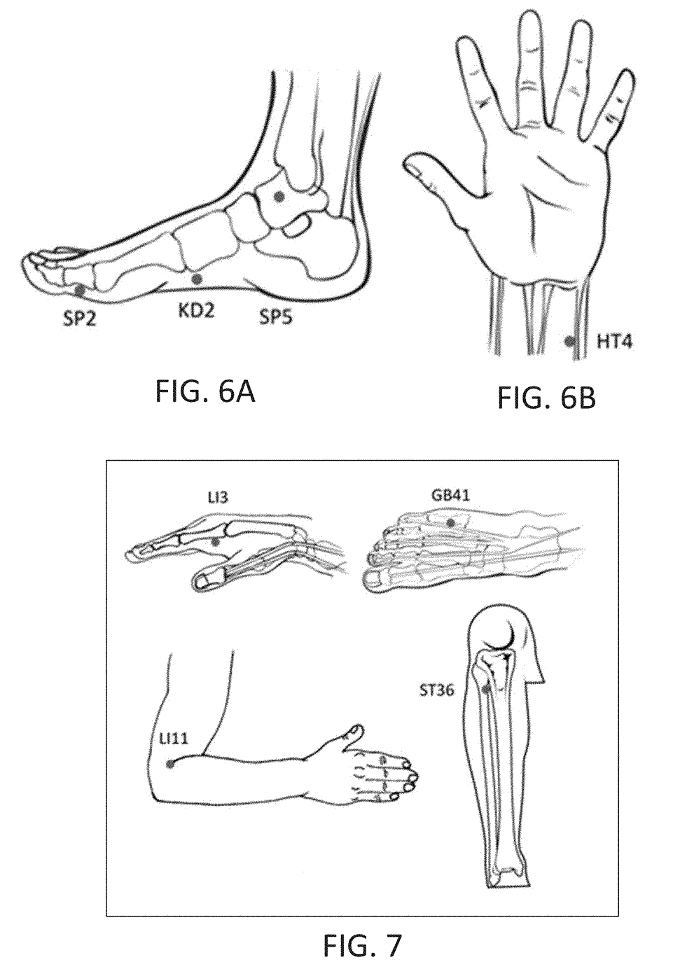

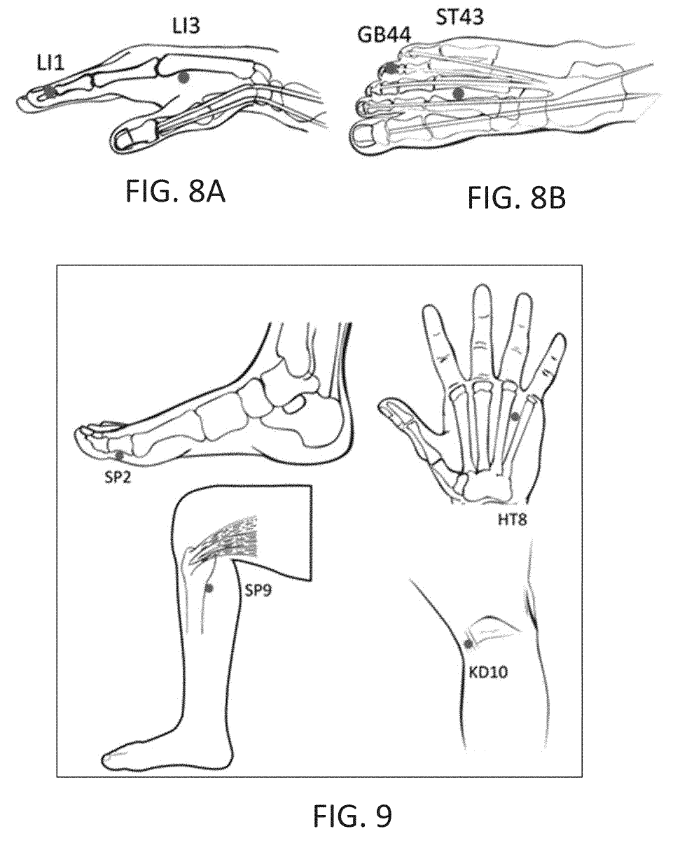

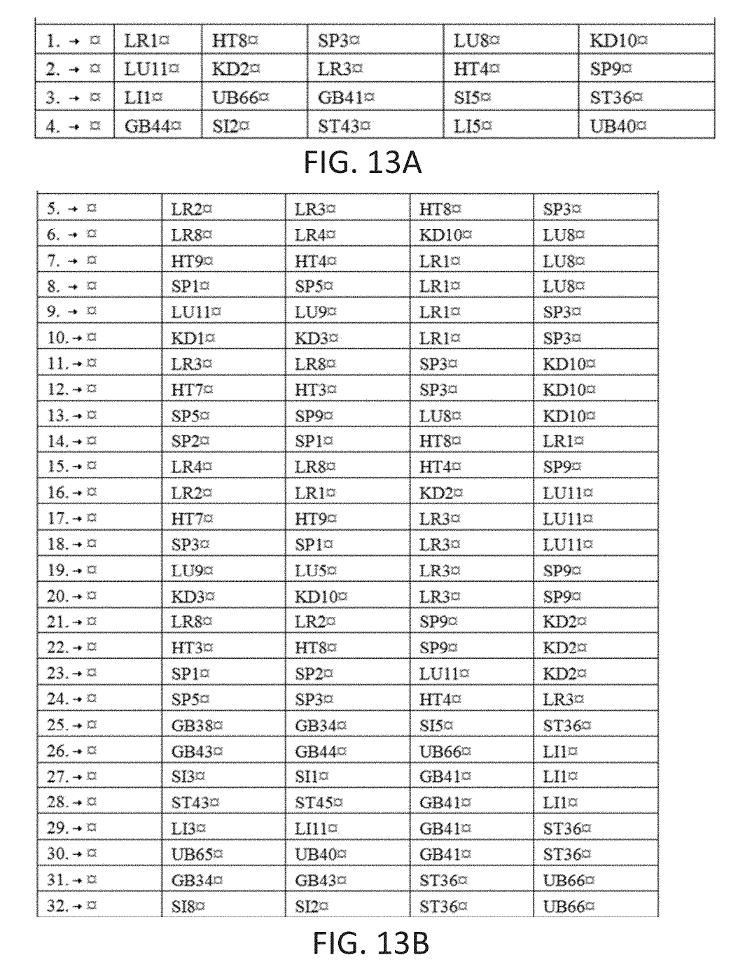

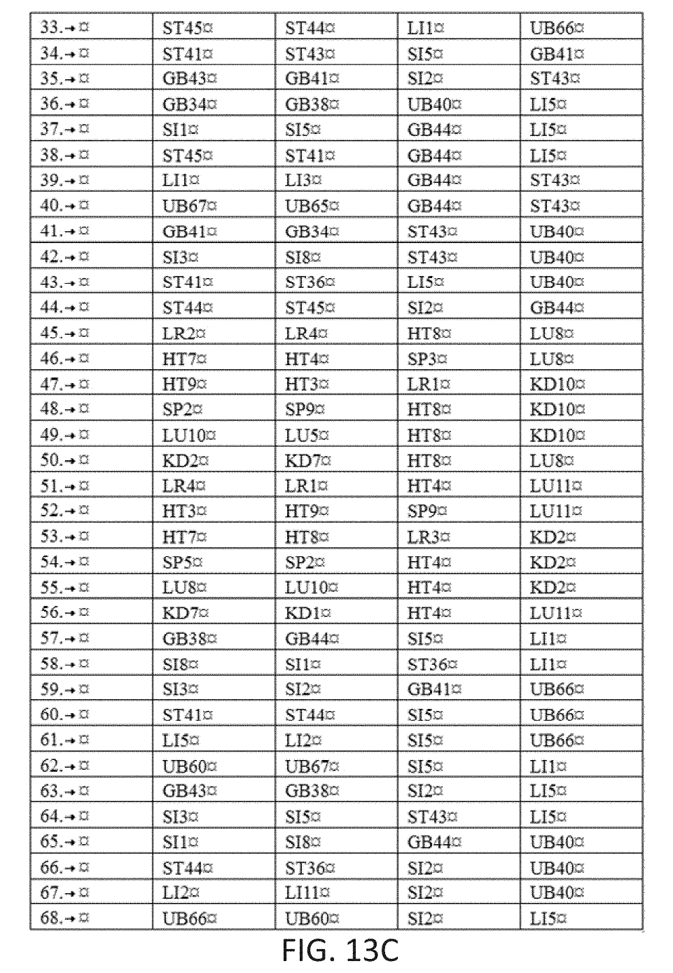

FIGS. 6A, 6B, 7, 8A, 8B, and 9 each illustrate one or more therapeutic location that corresponds to the locations and treatment protocols described in the tables shown in FIGS. 12 and 13A-C

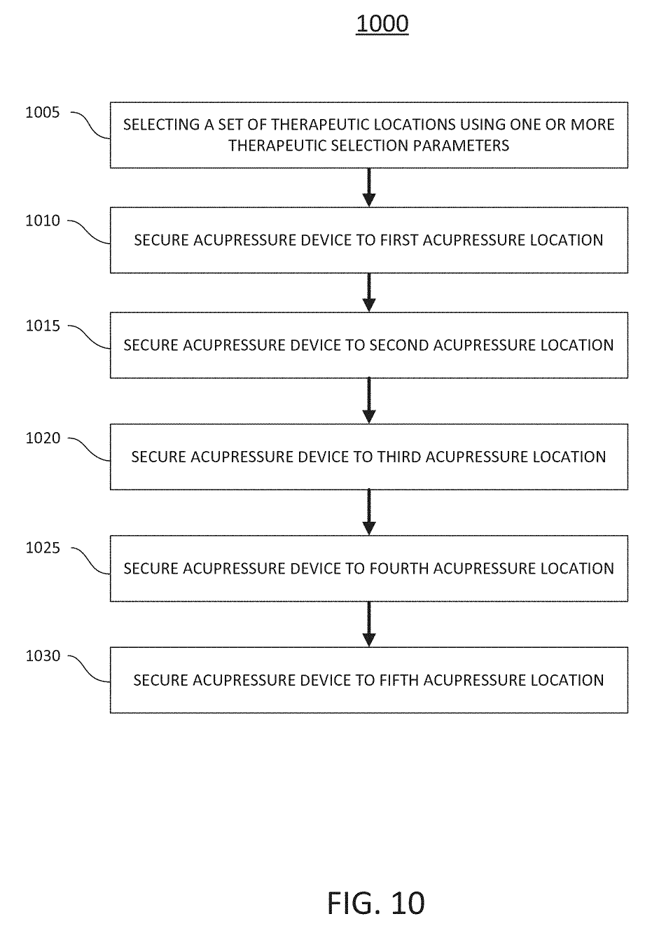

Consistent with the descriptions of multi-point acupressure protocols described above, FIG. 10 is a flow chart illustrating an example method for applying a multi-point treatment protocol. As illustrated, a method for stimulating a combination of acupressure points using a plurality of acupressure devices 1000 may include selecting a set of therapeutic locations using one or more therapeutic selection parameters at step 1005. For example, the therapeutic selection parameters may include selection of therapeutic locations corresponding separate horary channels and with targeted therapeutic impact to separate internal organs, per the protocols described with respect to FIGS. 2-5, and listed in the tables in FIGS. 13A-C. Therapeutic parameters may also include target diseases corresponding to particular therapeutic locations.

Method 1000 may also include securing an acupressure device to a first acupressure location at step 1010, e.g., as identified from multi-point protocols described above in reference to FIGS. 2-5 and as listed in tables in FIGS. 13A-C. Second, third, fourth, and fifth acupressure devices may then be secured to second, third, fourth, and fifth therapeutic locations in steps 1015, 1020, 1025, and 1030 respectively. As a result, acupressure devices may be secured to each therapeutic location in sequence, or simultaneous, as indicated by the specified combination protocol. The same process may also apply to acupuncture, as opposed to acupressure.

As described above, FIGS. 13A, 13B, and 13C include examples of effective multi-point combinations, wherein the method 1000 illustrated in FIG. 10 above may be applied using each example combination (one combination per row) identified in the tables each of FIGS. 13A, 13B, and 13C. The table shown in FIG. 13A lists example five-point combinations of therapeutic locations, whereas the tables shown in FIGS. 13B and 13C show four point combinations of therapeutic locations. Combinations with more than five points or less than four points may also be used according to the same principles as disclosed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for stimulating a combination of acupressure points using a plurality of acupressure devices, the method comprising:
selecting, based on one or more therapeutic selection parameters, a set of therapeutic locations;
applying a first acupressure device of the plurality of acupressure devices to a first location selected from the set of therapeutic locations;
applying a second acupressure device of the plurality of acupressure devices to a second location selected from the set of therapeutic locations;
applying a third acupressure device of the plurality of acupressure devices to a third location selected from the set of therapeutic locations; and
applying a fourth acupressure device of the plurality of acupressure devices to a fourth location selected from the set of therapeutic locations.

2. The method of claim 1, further comprising applying a fifth acupressure device of the plurality of acupressure devices to a fifth location selected from the set of therapeutic locations.

3. The method of claim 2, wherein the set of therapeutic locations comprises one or more bi-horary therapeutic locations.

4. The method of claim 3, wherein the one or more bi-horary therapeutic locations consists of a wood location, a fire location, an earth location, a metal location, and a water location.

5. The method of claim 4, wherein:
the wood location is a LR1 location, a LR3 location, a GB44 location, or a GB41 location;
the fire location is a HT8 location, a HT4 location, a SI2 location, or a SI5 location;
the earth location is a SP3 location, a SP9 location, a ST43 location, or a ST36 location;
the metal location is a LU8 location, a LU11 location, a LI5 location, or a LI1 location; and
the water location is a KD10 location, a KD2 location, a UB40 location, or a UB66 location.

6. The method of claim 1, wherein the one or more therapeutic selection parameters comprise a type of ailment affecting a body part.

7. The method of claim 6, wherein the one or more therapeutic selection parameters comprise a plurality of ailments affecting one or more body parts.

8. The method of claim 1, wherein each of the plurality of acupressure devices comprises a flat substrate and a plurality of knobs protruding from a distal surface of the flat substrate.

9. The method of claim 8, wherein applying each of the plurality of acupressure devices comprises securing, with an adhesive component, the acupressure device to a location selected from the set of therapeutic locations.

10. The method of claim 9, wherein the adhesive component comprises an adhesive tape.

11. A method for stimulating a combination of acupressure points using a plurality of acupressure devices, the method comprising:
selecting a set of bi-horary therapeutic locations;
securing, with an adhesive component, a first acupressure device of the plurality of acupressure devices to a first location selected from the set of bi-horary therapeutic locations;
securing, with an adhesive component, a second acupressure device of the plurality of acupressure devices to a second location selected from the set of bi-horary therapeutic locations;
securing, with an adhesive component, a third acupressure device of the plurality of acupressure devices to a third location selected from the set of bi-horary therapeutic locations;
securing, with an adhesive component, a fourth acupressure device of the plurality of acupressure devices to a fourth location selected from the set of bi-horary therapeutic locations; and
securing, with an adhesive component, a fifth acupressure device of the plurality of acupressure devices to a fifth location selected from the set of bi-horary therapeutic locations.

12. The method of claim 11, wherein the first location comprises a wood location or a metal location.

13. The method of claim 12, wherein the second location comprises a fire location or a water location.

14. The method of claim 13, wherein the third location comprises an earth location or the wood location.

15. The method of claim 14, wherein the fourth location comprises the metal location or the fire location.

16. The method of claim 15, wherein the fifth location comprises the water location or the earth location.

17. The method of claim 16, wherein:
the wood location is a LR1 location, a LR3 location, a GB44 location, or a GB41 location;
the fire location is a HT8 location, a HT4 location, a SI2 location, or a SI5 location;
the earth location is a SP3 location, a SP9 location, a ST43 location, or a ST36 location;
the metal location is a LU8 location, a LU11 location, a LI5 location, or a LI1 location; and
the water location is a KD10 location, a KD2 location, a UB40 location, or a UB66 location.

18. The method of claim 17, each of the plurality of acupressure devices comprises a flat substrate and a plurality of knobs protruding from a distal surface of the flat substrate.

19. The method of claim 9, wherein the adhesive component comprises an adhesive tape.

20. The method of claim 19, wherein the one or more therapeutic selection parameters comprise a type of ailment affecting a body part.
